(19) United States
(12) Patent Application Publication
(10) Pub. No.: US 2002/0184638 A1
(43) Pub. Date: Dec. 5, 2002

(54) Video playback device capable of sharing resources and method of operation

(75) Inventors: Lalitha Agnihotri, Fishkill, NY (US); Thomas F. McGee, Garrison, NY (US); Andrew T. Miller, New York City, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/866,823

(22) Filed: May 29, 2001

(51) Int. Cl. H04N 7/173; H04N 7/16

(52) U.S. Cl. 725/89; 725/134; 725/142

(57) ABSTRACT

There is disclosed a video playback device comprising: 1) a disk storage device for storing television programs received from an external source; 2) a first controller for receiving a first program recording command, wherein the first program recording command is operable to cause the first controller to store a first television program on the disk storage device during a first time slot; and 3) a second controller for determining if sufficient space is available on the disk storage device to store the first television program. The disk storage device, in response to a determination that sufficient space is not available on the disk storage device, identifies in an external communication network a second remote video playback device capable of recording the first television program and transmits a recording task request to the second remote video playback device. The recording task request causes the second remote video playback device to record the first television program during the first time slot.

### TECHNICAL FIELD OF THE INVENTION

The present invention is generally related to video playback devices and, more specifically, to a video playback device capable of sharing hardware resources with similar video playback devices via an external network.

### BACKGROUND OF THE INVENTION

A wide variety of video playback devices are available in the marketplace. Most people own, or are familiar with, a video cassette recorder (VCR). More recently, video recorders that use computer magnetic hard disks rather than magnetic cassette tapes to store video programs have appeared in the market. For example, the ReplayTV™ recorder and the TiVO™ recorder digitally record television programs on hard disk drives using, for example, MPEG-2 compression. Additionally, some video playback devices may record on a readable/writable digital versatile disk (DVD) rather than a magnetic disk.

The great advantage of a video playback device is that it permits a user to time-shift his or her television viewing habits. The user is free to watch a program hours, days or even weeks after it was originally recorded. Video playback devices also permit a user to view rented video.

Nonetheless, the capabilities of video playback devices are relatively limited. Video playback devices have a relatively limited amount of storage space that may easily be consumed by recorded television programs, which are typically many hundreds of megabits in size. Also, video playback devices are capable of recording only as many programs as there are tuners. A video playback device with a single tuner can only record one program at a time. If a viewer wishes to record two simultaneously broadcast programs, the viewer must use two video playback devices.

It is desirable to expand the capabilities of video playback devices. In particular, there is a need for an improved disk-based video playback device that is capable of recording a video program when there is insufficient free space remaining on the disk. More particularly, there is a need for an improved video playback device that is capable of recording two or more video programs at a time.

### SUMMARY OF THE INVENTION

To address the above-discussed deficiencies of the prior art, it is a primary object of the present invention to provide an improved video playback device containing a disk storage device that is capable of sharing resources with similar video playback devices via an external communication network connected to the video playback device. A first video playback device communicates with the other similar video playback devices and is able to determine if a second video playback device is currently in use and when it is scheduled to be in use. The first video playback device is also able to determine how much disk space is available on the second video playback device. If the second video playback device has resources available, the first video playback device is able to send the second video playback device a recording task that causes the second video playback device to record a television program under the control of the first video playback device.

To address the above-discussed deficiencies of the prior art, it is another primary object of the present invention to provide a video playback device comprising: 1) a disk storage device capable of storing television programs received from an external source; 2) a first controller capable of receiving a first program recording command, wherein the first program recording command is operable to cause the first controller to store a first television program on the disk storage device during a first time slot; and 3) a second controller capable of determining if sufficient space is available on the disk storage device to store the first television program, wherein the disk storage device, in response to a determination that sufficient space is not available on the disk storage device is further capable of identifying in an external communication network a second remote video playback device capable of recording the first television program and transmitting a recording task request to the second remote video playback device, wherein the recording task request is operable to cause the second remote video playback device to record the first television program during the first time slot.

According to one embodiment of the present invention, the second controller is further capable of comparing the first program recording command to a second program recording command previously received by the first controller and determining if a second time slot associated with the second program recording command overlaps the first time slot.

According to another embodiment of the present invention, the second controller, in response to a determination that the first and second time slots overlap, is further capable of accessing the second remote video playback device via the external communication network and transmitting the recording task request to the second remote video playback device, wherein the recording task request is operable to cause the second remote video playback device to record the first television program during the first time slot.

According to still another embodiment of the present invention, the video playback device further comprises a memory for storing the first and second program recording commands in a recording schedule table.

According to yet another embodiment of the present invention, the second controller identifies the second remote video playback device by accessing a central server in the external communication network and requesting from the central server a list of remote video playback devices capable of recording the first television program.

According to a further embodiment of the present invention, the second controller is capable of transmitting to the central server disk space status information regarding an amount of available space on the disk storage device.

According to a still further embodiment of the present invention, the second controller is further capable of transmitting to the central server a program recording schedule regarding television programs scheduled to be recorded by the video playback device.

According to a yet further embodiment of the present invention, the second controller is further capable of receiving from a third video playback device an incoming recording task request, wherein the incoming recording task request is operable to cause the video playback device to record a requested television program associated with the incoming recording task request.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary video playback device and television set according to one embodiment of the present invention;

FIG. 2 illustrates an exemplary video playback device in detail according to one embodiment of the present invention;

FIG. 3 illustrates an exemplary television program according to one embodiment of the present invention;

FIG. 4A illustrates the contents of a resource sharing server according to one embodiment of the present invention;

FIG. 4B illustrates the contents of the hard disk drive in the exemplary video playback device according to one embodiment of the present invention; and

FIG. 5 is a flow diagram illustrating the operation of an exemplary video playback device according to one embodiment of the present invention.

### DETAILED DESCRIPTION OF THE INVENTION

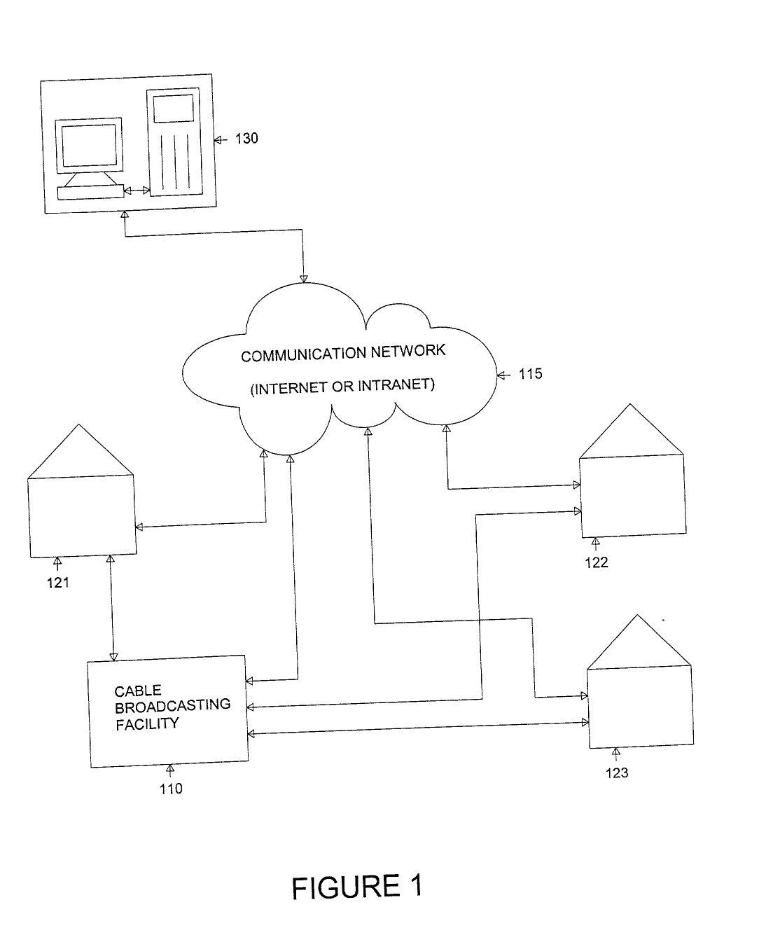

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged video playback device.

FIG. 1 illustrates a communication system in which a plurality of video playback devices in accordance with the principles of the present invention share hardware resources. Cable broadcasting facility 110 transmits television programs to subscriber premises 121, 122, and 123. Each of subscriber premises has therein a video playback device according to the principles of the present invention. As will be described below in greater detail, the video playback devices communicate via Internet protocol communication network 115 (hereafter simply Internet 115) in order to share hardware resource information and to send and receive programming tasks. According to an exemplary embodiment of the present invention, resource sharing server 130 acts as a central repository of information regarding available hardware resources on each video playback device that are available for sharing with other video playback devices.

The video playback devices in subscriber premises 121-123 may communicate over Internet 115 via cable modem connections to cable broadcasting facility 110. Alternatively, the video playback devices in subscriber premises 121-123 may communicate over Internet 115 via public switched telephone network (PSTN) connections, such as DSL connections or V.90 compatible modems. If the video playback devices in subscriber premises 121-123 communicate over Internet 115 using PSTN connections, cable broadcasting facility 110 may be replaced by a one-way wireless broadcasting system or a satellite television system.

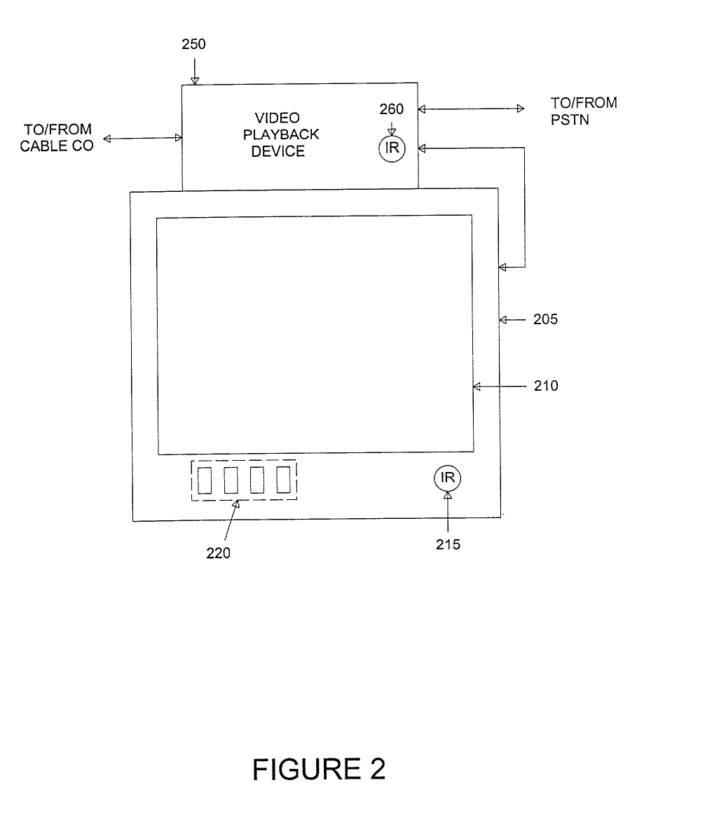

FIG. 2 illustrates exemplary video playback device 250 and television set 205 in subscriber premises 121 (from FIG. 1) according to one embodiment of the present invention. Video playback device 250 receives television signals via an external source, such as a cable broadcasting facility 110 (Cable Co.), or alternatively, via a satellite dish, or a local RF antenna. Video playback device 250 transmits a viewer-selected channel to television set 205. In an advantageous embodiment of the present invention, video playback device 250 also transmits and receives Internet protocol (IP) packets via a two-way cable connection to cable broadcasting facility 110. In other embodiments, video playback device 250 may also have the capability to send and receive Internet protocol (IP) packets signals via a connection to the public switched telephone network.

In RECORD mode, video playback device 250 may demodulate an incoming radio frequency (RF) television signal to produce a baseband video signal that is recorded and stored on a storage medium within or connected to video playback device 250. In PLAY mode, video playback device 250 reads a stored baseband video signal (i.e., program) selected by the user from the storage medium and transmits it to television set 205.

According to an exemplary embodiment of the present invention, video playback device 250 is a disk drive-based device, such as a ReplayTV recorder or a TiVO recorder. Video playback device 250 stores and retrieves the incoming television signals to and from a computer magnetic hard disk rather than a magnetic cassette tape. In other embodiments, video playback device 250 may store and retrieve from a local read/write (R/W) digital versatile disk (DVD) or R/W CD-ROM. Thus, the local storage medium may be fixed (i.e., hard disk drive) or removable (i.e., DVD, CD-ROM).

Video playback device 250 comprises infrared (IR) sensor 260 that receives commands (such as Channel Up, Channel Down, Volume Up, Volume Down, Record, Play, Fast Forward (FF), Reverse, and the like) from a remote control device operated by the user. Television set 205 is a conventional television comprising screen 210, infrared (IR) sensor 215, and one or more manual controls 220 (indicated by a dotted line). IR sensor 215 also receives commands (such as volume up, volume down, power ON/OFF) from a remote control device operated by the viewer.

It should be noted that video playback device 250 is not limited to receiving a particular type of incoming television signal from a particular type of source. As noted above, the external source may be a cable TV connection, a conventional RF broadcast antenna, or a satellite dish. The incoming television signal may be a digital signal, an analog signal, or Internet protocol (IP) packets. However, for the purposes of simplicity and clarity in explaining the principles of the present invention, the descriptions that follow shall generally be directed to an embodiment in which video playback device 250 receives incoming television signals and IP traffic from cable broadcasting facility 110.

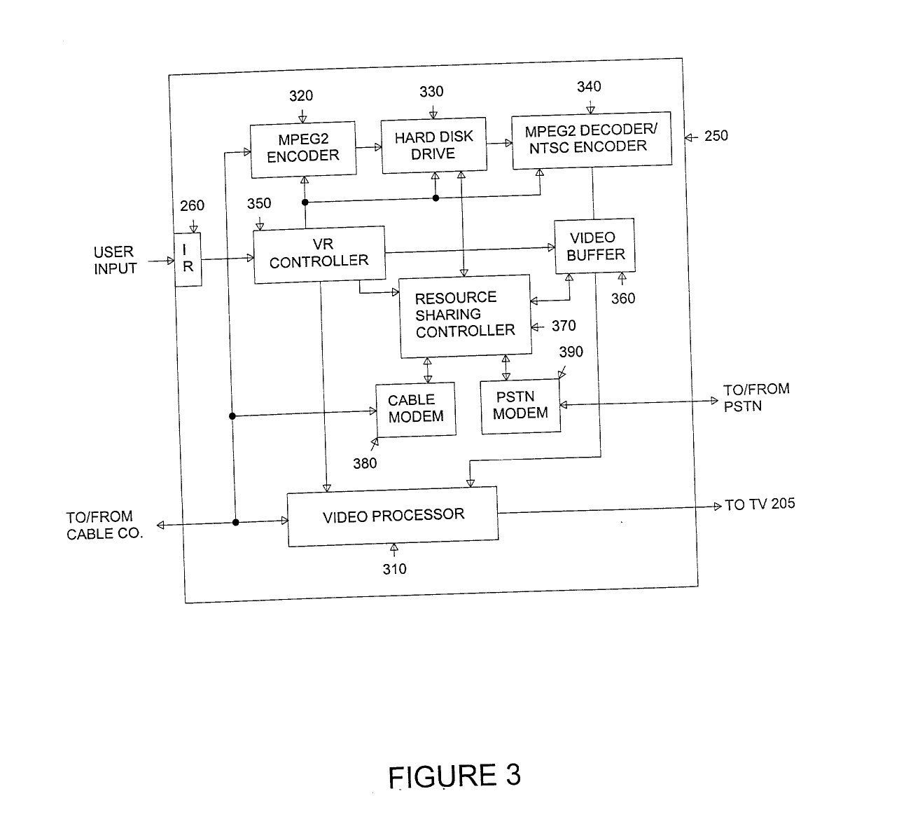

FIG. 3 illustrates exemplary video playback device 250 in greater detail according to one embodiment of the present invention. Video playback device 250 comprises IR sensor 260, video processor 310, MPEG2 encoder 320, hard disk drive 330, MPEG2 decoder/NTSC encoder 340, and video recorder (VR) controller 350. Video playback device 250 further comprises video buffer 360, resource sharing controller 370, cable modem 380 and PSTN modem 390. VR controller 350 directs the overall operation of video playback device 250, including View mode, Record mode, Play mode, Fast Forward (FF) mode, Reverse mode, Browser mode, and update mode, among others.

In VIEW mode, VR controller 350 causes the incoming television signal from the cable service provider to be demodulated and processed by video processor 310 and transmitted to television set 205, without storing or retrieving from hard disk drive 330. Video processor 310, which may be, for example, a TriMedia (TM) 2000 media processor, contains radio frequency (RF) front-end circuitry for receiving incoming television signals from the cable service provider, tuning to a user-selected channel, and converting the selected RF signal to a baseband television signal (e.g., super video or S-Video signal) suitable for display on television set 205. Video processor 310 also may receive a conventional NTSC signal from MPEG2 decoder/NTSC encoder 340 (after buffering in video buffer 360) during Play mode and transmitting a baseband television signal (e.g., S-Video signal) to television set 205.

In RECORD mode, VR controller 350 causes the incoming television signal to be stored on hard disk drive 330. Under the control of VR controller 350, MPEG2 encoder 320 receives the incoming television signal from the cable service provider and converts the received RF signal to MPEG format for storage on hard disk drive 330. In PLAY mode, VR controller 350 directs hard disk drive 330 to stream the stored television signal (i.e., program) to MPEG2 decoder/NTSC encoder 340, which converts the MPEG2 data retrieved from hard disk drive 330 to, for example, an S-Video signal that is buffered in video buffer 360 before video processor 310 transmits it to television set 305.

It should be noted that the choice of the MPEG2 standard for MPEG2 encoder 320 and MPEG2 decoder/NTSC encoder 340 is by way of illustration only. In alternate embodiments of the present invention, the MPEG encoder and decoder may comply with one or more of the MPEG-1, MPEG-2, and MPEG-4 standards.

For the purposes of this application and the claims that follow, hard disk drive 330 is defined to include any mass storage device that is both readable and writable, including conventional magnetic disk drives and optical disk drives for read/write digital versatile disks (DVD-RW), re-writable CD-ROMs, VCR tapes and the like. In fact, hard disk drive 330 need not be fixed in the conventional sense that is permanently embedded in video playback device 250. Rather, hard disk drive 330 includes any mass storage device that is dedicated to video playback device 250 for the purpose of storing recorded video programs. Thus, hard disk drive 330 may include an attached peripheral drive or removable disk drives (whether embedded or attached), such as a jukebox device that holds read/write DVDs or re-writable CD-ROMs. Furthermore, in an advantageous embodiment of the present invention, hard disk drive 330 may include external mass storage devices that video playback device 250 may access and control via a network connection (e.g., Internet protocol (IP) connection), including, for example, a disk drive in the user's home personal computer (PC) or a disk drive on a server at the user's Internet service provider (ISP).

In accordance with the principles of the present invention, resource sharing controller 370 is capable of accessing resource sharing server 130 via Internet 115 via cable modem 380 or public switched telephone network (PSTN) modem 390. When the user programs video playback device 250 to record a newly requested program between certain start and stop times, resource sharing controller 370 is able to determine (according to the recording duration) whether or not there is sufficient disk space to record the requested program. Resource sharing controller 370 is also able to determine if the programming times of the newly requested program overlap with the recording times of an already scheduled recording. If there is insufficient disk space or if there is conflict with another scheduled programming, resource sharing controller is capable of searching for available resources on resource sharing server 130. When available resources are found on a second video playback device, resource sharing controller 370 can transmit a recording task to the second video playback device. In an advantageous embodiment of the present invention, resource sharing controller 370 may transmit several recording tasks to several different video playback devices as redundant backups in case a conflict arises after an initial recording task is sent to the second video playback device. Resource sharing controller 370 also is able to receive and to perform a recording task transmitted by another video playback device.

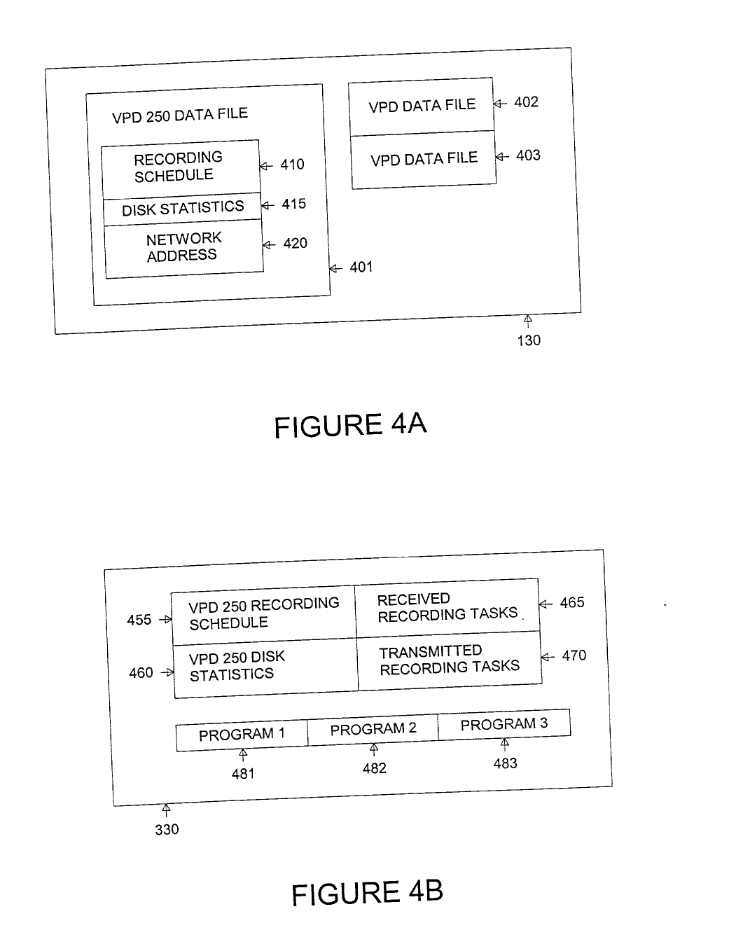

FIG. 4A illustrates the contents of resource sharing server 130 according to one embodiment of the present invention. Resource sharing server 130 stores exemplary video playback device (VPD) data files 401-403, each of which contains information about the availability of the hardware resources of one of the video playback devices that communicates with resource sharing server 130. Exemplary VPD data file 401 is the VPD data file for video playback device 250. VPD data file 401 comprises recording schedule table 410, disk statistics table 415, and network address table 420. VPD data files 402 and 403 are functionally equivalent to VPD data file 401 and need not be discussed in separate detail.

Recording schedule table 410 contains a listing of all of the television programs that video playback device 250 is scheduled to record. Optionally, recording schedule table 410 may also contain a listing of all previously recorded television programs, in order to avoid redundant recordings. Disk statistics table 415 indicates the amount of disk space that is used and the amount of disk space that is free for recording programs. Finally, network address table 420 contains the network address of video playback device 250. Other video playback devices use the network address of video playback device 250 to transmit recording task requests to video playback device 250. When resource sharing server 130 receives a resource availability request from other remote video playback devices, resource sharing server 130 may use the information stored in VPD data files 401, 402, and 403 to determine which video playback devices are able to perform the recording task associated with the resource availability request. Alternatively, resource sharing server 130 may transmit the information stored in VPD data files 401, 402, and 403 to the requesting remote video playback device, which then determines which video playback devices are able to perform the recording task associated with the resource availability request.

FIG. 4B illustrates the contents of hard disk drive 230 according to one embodiment of the present invention. Hard disk drive 230 stores recording schedule table 455 of video playback device 250, disk statistics table 460 for remote video playback device 250, received recording tasks table 465, and transmitted recording tasks table 470. Additionally, hard disk drive 330 stores exemplary television programs 481, 482, and 483, which are arbitrarily labeled Program 1, Program 2, and Program 3, respectively.

When video playback device 250 transmits a recording task request to a remote video playback device, a copy of the recording task request is stored in transmitted recording tasks table 470. Video playback device 250 uses the data in transmitted recording tasks table 470 to keep track of outstanding recording tasks and to retrieve the recorded program once recording is complete. When video playback device 250 receives a recording task request from a remote video playback device, a copy of the recording task request is stored in received recording tasks table 470. Video playback device 250 uses the data in received recording tasks table 470 to keep track of outstanding recording tasks and to transmit the recorded program to the correct destination. In an advantageous embodiment of the present invention, if video playback device 250 receives a recording task for a television program that already has been recorded and stored in video playback device 250, video playback device 250 may simply (and immediately) transmit the already recorded copy of the television program via Internet 115 to the requesting video playback device, instead of recording it. Video playback device 250 also uses the data in received recording tasks table 470 to update recording schedule table 455. Thus, recording schedule table 455 contains a listing of all recording tasks that are entered by the user of video playback device 250 and all recording tasks that are received from other video playback devices and accepted by video playback device 250. Finally, disk statistics table 460 indicates the amount of disk space that is used on video playback device 460 and the amount of disk space that remains free for recording programs.

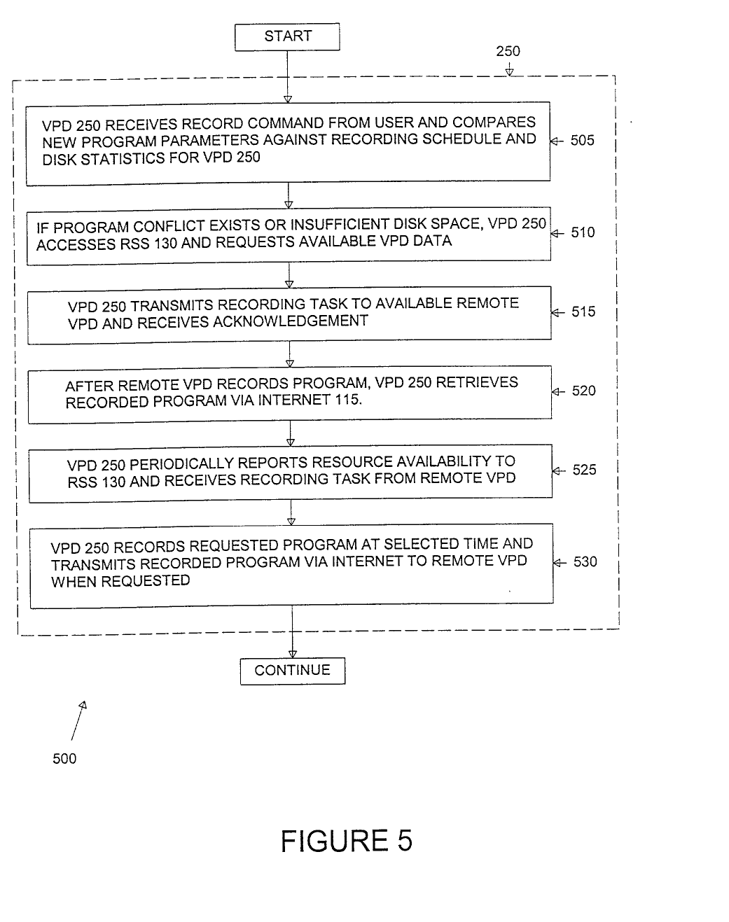

FIG. 5 depicts flow diagram 500, which illustrate the operation of exemplary video playback device 500 according to one embodiment of the present invention. Initially, video playback device 250 receives a RECORD command from the user and compares the new program parameters (e.g., start time, stop time) against the recording schedule 455 and disk statistics 460 for video playback device 250 (process step 505). If a programming conflict exists, or if there is insufficient disk space, video playback device 250 accesses resource sharing server 130 and requests data regarding available video playback devices (process step 510). At this point, video playback device 250 may select a remote video playback device to perform the requested recording. Alternatively, resource sharing server 130 may select a remote video playback device to perform the requested recording. Resource sharing server 130 then transmits the relevant information about the selected remote video playback device to video playback device 250.

In any event, video playback device 250 transmits a recording task to the available remote video playback device and receives an acknowledgment in return (process step 515). If an acknowledge is not received, video playback device 250 may select another remote video playback device, instead. After remote video playback device records the requested program, video playback device 250 retrieves the recorded program via Internet 115 (process step 520).

Additionally, video playback device 250 periodically reports resource availability to resource sharing server 130 and receives recording task from remote video playback device (process step 525). Video playback device 250 records requested program at selected time and transmits recorded program via internet to remote video playback device when requested (process step 530).

Although the present invention has been described in detail, those skilled in the art should understand that they can make various changes, substitutions and alterations herein without departing from the spirit and scope of the invention in its broadest form.

What is claimed is:

1. A video playback device comprising:
a disk storage device capable of storing television programs received from an external source;
a first controller capable of receiving a first program recording command, wherein said first program recording command is operable to cause said first controller to store a first television program on said disk storage device during a first time slot; and
a second controller capable of determining if sufficient space is available on said disk storage device to store said first television program, wherein said disk storage device, in response to a determination that sufficient space is not available on said disk storage device is further capable of identifying in an external communication network a second remote video playback device capable of recording said first television program and transmitting a recording task request to said second remote video playback device, wherein said recording task request is operable to cause said second remote video playback device to record said first television program during said first time slot.

2. The video playback device as set forth in claim 1 wherein said second controller is further capable of comparing said first program recording command to a second program recording command previously received by said first controller and determining if a second time slot associated with said second program recording command overlaps said first time slot.

3. The video playback device as set forth in claim 2 wherein said second controller, in response to a determination that said first and second time slots overlap, is further capable of accessing said second remote video playback device via said external communication network and transmitting said recording task request to said second remote video playback device, wherein said recording task request is operable to cause said second remote video playback device to record said first television program during said first time slot.

4. The video playback device as set forth in claim 3 further comprising a memory for storing said first and second program recording commands in a recording schedule table.

5. The video playback device as set forth in claim 3 wherein said second controller identifies said second remote video playback device by accessing a central server in said external communication network and requesting from said central server a list of remote video playback devices capable of recording said first television program.

6. The video playback device as set forth in claim 5 wherein said second controller is capable of transmitting to said central server disk space status information regarding an amount of available space on said disk storage device.

7. The video playback device as set forth in claim 6 wherein said second controller is further capable of transmitting to said central server a program recording schedule regarding television programs scheduled to be recorded by said video playback device.

8. The video playback device as set forth in claim 7 wherein said second controller is further capable of receiving from a third video playback device an incoming recording task request, wherein said incoming recording task request is operable to cause said video playback device to record a requested television program associated with said incoming recording task request.

9. A method of operating a video playback device comprising a disk storage device capable of storing television programs received from an external source, the method comprising the steps of:
receiving a first program recording command, wherein the first program recording command is operable to cause the video playback device to store a first television program on the disk storage device during a first time slot;
determining if sufficient space is available on the disk storage device to store the first television program;
in response to a determination that sufficient space is not available on the disk storage device, identifying in an external communication network a second remote video playback device capable of recording the first television program; and
transmitting a recording task request to the second remote video playback device, wherein the recording task request is operable to cause the second remote video playback device to record the first television program during the first time slot.

10. The method as set forth in claim 9 comprising the further steps of:
comparing the first program recording command to a second program recording command previously received by the first controller; and
determining if a second time slot associated with the second program recording command overlaps the first time slot.

11. The method as set forth in claim 10 comprising the further steps of:
in response to a determination that the first and second time slots overlap, accessing the second remote video playback device via the external communication network; and
transmitting the recording task request to the second remote video playback device, wherein the recording task request is operable to cause the second remote video playback device to record the first television program during the first time slot.

12. The method as set forth in claim 11 wherein the disk storage device stores the first and second program recording commands in a recording schedule table.

13. The method as set forth in claim 11 wherein the step of identifying the second remote video playback device comprises the sub-steps of:
accessing a central server in the external communication network; and
requesting from the central server a list of remote video playback devices capable of recording the first television program.

14. The method as set forth in claim 13 further comprising the steps of:
transmitting to the central server disk space status information regarding an amount of available space on the disk storage device.

15. The method as set forth in claim 14 further comprising the steps of transmitting to the central server a program recording schedule regarding television programs scheduled to be recorded by the video playback device.

16. The method as set forth in claim 15 further comprising the steps of:
receiving from a third video playback device an incoming recording task request, wherein the incoming recording task request is operable to cause the video playback device to record a requested television program associated with the incoming recording task request.

17. For use in a communication network coupled to a plurality of video playback devices, a server comprising a memory for storing a plurality of data files related to said plurality of video playback devices, wherein each of said plurality of data files comprises a disk status indicator indicating an amount of free space available on a disk drive in a selected one of said video playback devices.

18. The server as set forth in claim 17 wherein each of said plurality of data files further comprises a recording schedule table indicating a list of television programs scheduled to be recorded by said selected one of said video playback devices.

19. The server as set forth in claim 18 wherein said server is capable of receiving from a first one of said video playback devices a recording task request associated with a first television program, wherein said server, in response to receipt of said recording task request determines a second one of said video playback devices capable of recording said first television program.

20. The server as set forth in claim 19 wherein said server transmits to said first video playback device a network address associated with said second video playback device.
